(19) United States
(12) Patent Application Publication
(10) Pub. No.: US 2009/0057234 A1
(43) Pub. Date: Mar. 5, 2009

(54) METHOD FOR MAKING BROWN GREASE

(75) Inventors: John Noble ARMSTRONG, Elizabethtown, NC (US); Cory Allen Johnson, Elizabethtown, NC (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: SF Investments, Inc., Wilmington, DE (US)

(21) Appl. No.: 11/850,351

(22) Filed: Sep. 5, 2007

(51) Int. Cl. C02F 1/02; C02F 1/24

(52) U.S. Cl. 210/703; 210/175; 210/806; 210/737; 210/202; 210/221.1

(57) ABSTRACT

A method and system for recovering grease from wastewater is disclosed. According to one embodiment of the present invention, the method includes receiving wastewater comprising an aqueous phase and an organic phase, wherein the organic phase comprises solids and grease; pretreating the wastewater to produce a waste sludge stream comprising water, solids, and grease, wherein a substantial amount of the solids and grease from the wastewater are extracted into the waste sludge stream; separating the waste sludge in a first separation stage to provide a first separation phase consisting essentially of solids, and a second separation phase comprising an immiscible liquid mixture of grease and water; and separating the second separation phase to provide a third separation phase consisting essentially of water and a fourth separation phase consisting essentially of grease. According to another embodiment of the present invention, the system includes a pretreatment facility capable of extracting a substantial portion of the solids from the wastewater stream to produce a waste sludge; a first separator capable of separating the waste sludge into a first separation phase consisting essentially of solids from the waste sludge, and a second separation phase comprising an immiscible mixture of water and grease; a second separator capable of separating the second separation phase into a third separation phase consisting essentially of water, and a fourth separation phase consisting essentially of grease.

### BACKGROUND OF THE ART

1. Field Of The Art

The embodiments generally relate to a method and system for treating wastewater to recover grease. More particularly, the embodiments relate to receiving wastewater from an animal processing plant, pretreating the wastewater in order to extract waste sludge, and separating the waste sludge into components such as solids, water, and grease.

2. Description Of Related Art

Animal processing plants, such as poultry plants, cattle slaughter houses, rendering plants, and seafood processing plants, generate substantial quantities of organic waste. Typically, the wastewater from an animal processing plant contains waste material from a variety of sources such as floor drains, blood troughs, and livestock pen drains. Wastewater from an animal processing plant typically contains blood, fat, muscle, bone, nails, intestinal contents, grit, and sand, among other things, mixed with water. Often, in addition to animal by-products, wastewater contains biological and chemical contaminants.

Because the wastewater from an animal processing plant has a high potential for contaminating water supplies, animal processing plants typically have a pretreatment facility to initially treat the wastewater before it is sent to a secondary treatment facility. Pretreatment often reduces or eliminates contaminants from the wastewater by removing waste sludge from the wastewater.

After the waste sludge is removed, the clarified water may be suitable for discharge into local sewers, rivers, or municipal wastewater treatment plants. This practice, however, leaves the problem of disposing the waste sludge. One common method for disposing waste sludge is by hauling the waste sludge away to a landfill. However, landfill disposal may be costly due to haulage or transport costs, and dumping fees. Transport costs are typically calculated on a weight basis or per wet pound of waste sludge hauled. In addition, disposing waste sludge in landfills poses potential environmental hazards, including groundwater contamination from leaching, and production of gas, including greenhouse gases.

While most components of waste sludge are not typically useful, it is believed that some components may have economic value. Waste sludge contains fat, blood, tissue, and other organic solids that may have nutritional value, or economic value, if recovered. Recovering these components from the large amount of waste sludge generated by animal processing plants has the benefit of reducing costs and potential pollution hazards associated with waste sludge disposal.

Some work has been done to develop methods to recover components of waste sludge having nutritional value for use in feed and fertilizer. For example, U.S. Pat. No. 6,235,339 (incorporated herein by reference in its entirety), discloses a method of chemically treating the waste stream of an animal processing plant to recycle the fat, blood tissue, and other organic solids typically found in the stream, and having use in feedstock. U.S. Pat. No. 6,368,657 (incorporated herein by reference in its entirety) discloses a waste sludge treatment method to precipitate and recover certain components having nutritional value, and converting them into a value-added product for feed and fertilizer applications.

In addition to components with nutritional value, wastewater may contain a significant quantity of grease, which, if recovered, may be equivalent to heavy industrial fuel oil and may be burned in boilers to generate steam. At present, the grease is estimated to be worth at least 20 cents per pound. More importantly, with the rising cost of fuel, the grease may be used in a cogeneration arrangement or as fuel in the animal processing plant to defray energy costs.

The description herein of certain advantages and disadvantages of known processes, methods, and compositions, is not intended to limit the scope of the embodiments.

### SUMMARY OF THE INVENTION

In view of the foregoing, there exists a need for a method and system of efficiently recovering grease from wastewater generated by an animal processing plant. The recovered grease may be reused in a cogeneration arrangement or as fuel in the animal processing plant. Separating the grease from wastewater also reduces the amount of solid waste, which may reduce disposal costs and potential environmental concerns.

It is therefore a feature of an embodiment a method for recovering grease from wastewater, the method comprising receiving wastewater comprising an aqueous phase and an organic phase, wherein the organic phase comprises solids and grease; pretreating the wastewater to produce a waste sludge stream comprising water, solids, and grease, wherein a substantial amount of the solids and grease from the wastewater are extracted into the waste sludge stream; separating the waste sludge in a first separation stage to provide a first separation phase consisting essentially of solids, and a second separation phase comprising an immiscible liquid mixture of grease and water; and separating the second separation phase to provide a third separation phase consisting essentially of water and a fourth separation phase consisting essentially of grease.

It is therefore another feature of an embodiment A system for recovering grease from wastewater, the system comprising a pretreatment facility capable of extracting a substantial portion of the solids from the wastewater stream to produce a waste sludge; a first separator capable of separating the waste sludge into a first separation phase consisting essentially of solids from the waste sludge, and a second separation phase comprising an immiscible mixture of water and grease; a second separator capable of separating the second separation phase into a third separation phase consisting essentially of water, and a fourth separation phase consisting essentially of grease.

These and other objects, features and advantages will appear more fully from the following detailed description of the preferred embodiments, and the attached drawings.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a schematic illustration of a process for treating a wastewater stream from an animal processing plant to recover grease, in accordance with one embodiment described herein.

### DETAILED DESCRIPTION OF EMBODIMENTS

The various embodiments described herein provide a method and system and for treating wastewater to recover grease. Although the present invention is described in the context of processing wastewater from an animal processing plant (e.g. poultry plants, cattle slaughter houses, rendering plants, and seafood processing plants), the invention is not so limited. Rather, the present invention has application to processing all types of wastewater.

Wastewater from animal processing facilities generally has an “organic phase” and an “aqueous phase.” The organic phase is commonly referred to as waste sludge. The organic phase or waste sludge has a substantial amount solid matter, and typically includes, without limitation, fats, oil, grease, and solids. The aqueous phase is primarily water, which may have some residual solids.

In various embodiments, certain process elements are identified as “fluidly connected” with other upstream or downstream processes or elements. As used herein, the term “fluidly connected” means connected by a fluid transfer conduit or any other method that permits fluid transfer, with or without intervening elements, such as, without limitation, containers, filters, devices, pumps, valves, and so on. For example, two vessels may be fluidly connected if they are connected through a pipe or tube, even if a pump, manifold, valve or other device exists in-line between the vessels. Two elements are considered fluidly connected even when there is no physical connection between the two elements, if the first element spills or otherwise drains, overflows, siphons, or transfers into the second element. As used herein, the term “downstream” in a process system means later in the direction of general process or fluid flow, and the term “upstream” means earlier in the direction of general process or fluid flow.

Moreover, this disclosure is not limited to particular embodiments described herein, because such embodiments may vary. Also, the terminology used herein is for the purpose of describing particular embodiments only and is not intended to be limiting. The scope of the present disclosure will be limited only by the appended claims.

In various embodiments, fluid is transferred either by gravity or pumping. In certain processes, fluid may be transferred by siphoning or by draining, relying on pressure differentials and gravity. Where gravity is insufficient to provide enough pressure for the fluid to flow to its destination, one or more pumps may be required. Those having ordinary skill in the art, with the teachings provided herein, would be able to assess the fluid transport requirements of the process, and specify an appropriate pump (if any) or alternative fluid transport means. For example, some factors to consider in this determination include, without limitation, the distance between components, the fluid conduit diameter and composition (friction), the viscosity of the fluid to be transferred, the vertical position of the inlet end of the fluid conduit relative to the outlet end of the fluid conduit, and the required pressure at the outlet end of the fluid conduit. Different types of pumps can be used depending on the process and operating condition, including, without limitation, a centrifugal pump, or a positive displacement pump.

The embodiments will now be described more fully with reference to the accompanying drawings in which some, but not all, embodiments are illustrated.

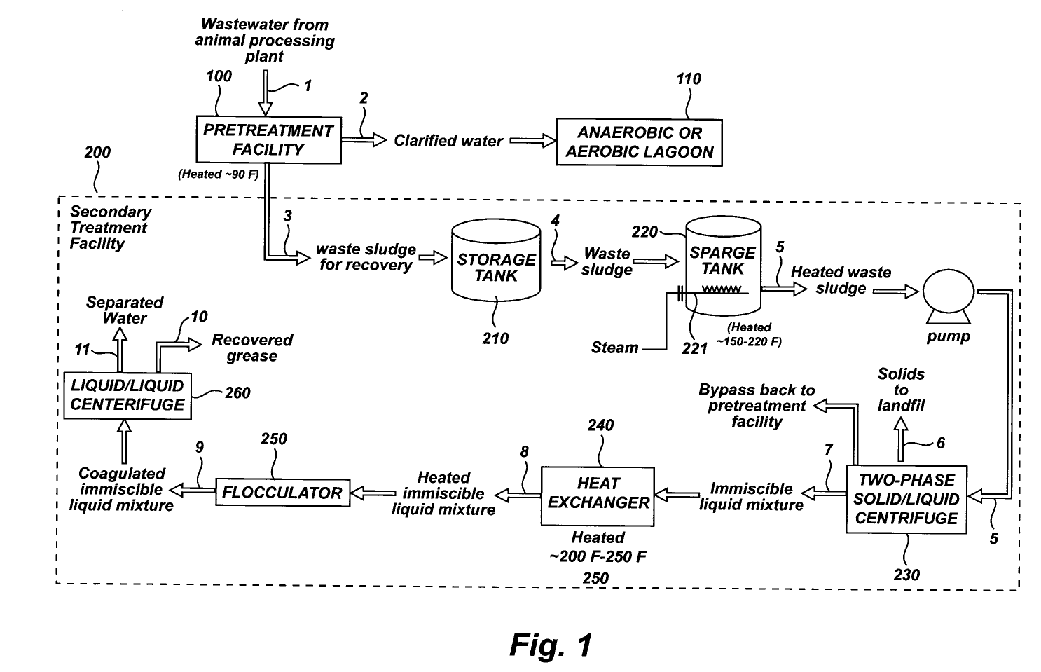

FIG. 1 illustrates an exemplary embodiment of a wastewater treatment process, in which an influent wastewater stream 1 from an animal processing plant may be fluidly connected to a pretreatment system 100. Influent wastewater stream 1 flows to pretreatment facility 100 and may be fed by variety of sources from inside or outside the animal processing plant. For example, wastewater may comprise streams from floor drains, blood troughs, and livestock pen drains. Wastewater stream 1 may comprise materials that include, without limitation, organic animal matter like animal waste, blood, fine bone, tissue, muscle, hair, nails, and so on. In addition to organic matter, wastewater stream 1 may also have chemicals and surfactants, or other contaminants, that may be used inside the animal processing plant. The makeup of the animal processing plant wastewater stream 1, however, may change daily, and those of ordinary skill in the art recognize that frequent and wide fluctuations in the wastewater makeup are normal. Surface runoff may also mix with wastewater stream 1 and flow in pretreatment facility 100.

In one embodiment, wastewater stream 1 flows by gravity without any controls to the pretreatment facility 100. In alternative embodiments, the flow rate of wastewater stream 1 may be controlled by one or more mechanisms. For example, in one embodiment, wastewater stream 1 may be collected in holding tanks located at the animal processing plant, between the animal processing plan and pretreatment facility 100, or at pretreatment facility 100. These holding tanks, such as a flow equalization basin or surge tank, may allow for a more regulated flow rate of wastewater stream 1 to pretreatment facility 100. In another embodiment, wastewater stream 1 may be pumped from the processing plant or from holding tanks to pretreatment facility 100.

As shown in FIG. 1, pretreatment facility 100, may be a dissolved air flotation (“DAF”) system. DAF may be one of several processes commonly used to clean and purify water by removing a substantial portion of the waste sludge and other contaminants from wastewater stream 1. The typical components of a DAF system, not shown, may be a flotation tank and a dissolved air supply, a flocculation tank and influent/coagulant mixing system, a skimmer assembly, a waste collecting system, and post-treatment tanks. Generally, the flotation tank may be used to mix wastewater stream 1 with a stream of water containing a large amount of dissolved air. The bubbles produced from the dissolved air attach to the solids and contaminants in wastewater stream 1 and cause a substantial amount of the solids and contaminants to float to the top of the tank.

The solids and contaminants that float to the top collect in a layer, referred to as waste sludge. The layer of waste sludge that collects at the surface of the flotation tank may be a mixture of about 60%-90% water, about 10%-30% grease, and about 5%-30% solids. The waste sludge typically includes, without limitation, fats, oils, sand, grease, low-density grit, bone chips, blood, and tissue. The water layer beneath the waste sludge, commonly referred to as clean water, may be removed from the flotation tank through clean water outputs. The solids and contaminants that do not float to the surface collect at the bottom of the flotation tank. This bottom layer of sludge typically includes, without limitation, hair, high-density grit, and sand. The DAF flotation tank may be of any conventional type or shape. The DAF flotation tank may be constructed from steel or other material resistive to corrosion and heat.

A skimmer assembly may remove the waste sludge from the top of the flotation tank, as is well known in the art. A second skimmer or mechanical arm at the bottom of the tank may remove waste sludge that has accumulated at the bottom of the flotation tank, as is also well known in the art.

In an alternative embodiment, pretreatment facility 100, may include one or more alternative processes (in addition to or as an alternative to the DAF) to clean and purify water. For example, pretreatment facility 100 may be a membrane separation system. Membrane separation systems may also remove a substantial portion of waste sludge in the wastewater stream 1. Such systems have a permeable membrane with a specific pore size determined by process conditions. The membrane allows the aqueous phase of the wastewater to pass through, while separating out the organic phase from the wastewater. After a sufficient amount of waste sludge settles at the bottom of a filtration vessel that houses the membrane, the sludge may be removed via a sludge discharge stream by pump or gravity to a post-treatment tank.

In another alternative embodiment, pretreatment facility 100 may include multiple DAF systems in series adapted to sequentially remove the solid particles in wastewater stream 1. In still another embodiment, pretreatment facility 100 may be a combination of a DAF system with a membrane separation system. Pretreatment facility 100 used in an animal processing plant is not limited to the representative embodiments described above, and may include any variation that separates waste sludge from wastewater stream 1.

As shown in FIG. 1, the clean water stream 2 from the pretreatment facility may be fluidly connected to at least one onsite anaerobic or aerobic lagoon 110. Typically, animal processing plants have at least one anaerobic or aerobic lagoon 110 to produce methane. The methane generated by lagoon 110 may be used as a fuel source and is often used in a cogeneration arrangement. To take full advantage of this benefit, the methane production of lagoon 110 may be maximized.

In one embodiment, pretreatment facility 100 may be maintained at a temperature of about 90° F. Recycling the clean water stream 2 to lagoon 110 at about 90° F. may maximize methane production. In an alternative embodiment, pretreatment facility 100 may be maintained at ambient temperature, and clean water stream 2 may be heated externally before it is introduced into anaerobic or aerobic lagoon 110. It is appreciated by those of ordinary skill in the art that the temperature of pretreatment facility 100 may range from ambient temperature to temperatures above 100° F. The optimal temperature may depend on a number of variables like particular processing plant equipment, optimal conditions for methane production in an anaerobic or aerobic lagoon, or other operating constraints.

Once the waste sludge has been separated from the wastewater in pretreatment facility 100, the waste sludge may be pumped or gravity fed from pretreatment facility 100 to a secondary treatment facility 200.

In a one embodiment, the waste sludge stream 3 may be pumped from pretreatment facility 100 to a storage tank 210. Storage tank 210 may be of any conventional type or shape, suitable for storing the waste sludge. Storage tank 210 may be made of steel or other material resistive to corrosion and heat. In one embodiment, storage tank 210 may simply serve as a flow regulating tank or pre-feed holding tank in secondary treatment facility 200.

In another embodiment, storage tank 210 may have an agitator for agitating the waste sludge to maintain a uniform mixture and consistency. Agitation prevents the components, mainly the solids and grease, from separating or settling. The agitator may include any conventional or later-developed mixing or agitation device, such as an impeller, for mixing the contents of storage tank 210.

In another embodiment, storage tank 210 may additionally have a heater adapted to evenly heat the waste sludge. The heater maintains the waste sludge in storage tank 210 at a temperature of about 90° F. Depending on the waste sludge's composition, viscosity, and propensity to solidify, the temperature of storage tank 210 may be varied as necessary to prevent settling or solidification. Any suitable device may be used as a heater. For example, the heater means for storage tank 210 may be a jacketed tank through which steam is circulated. The temperature of the waste sludge may be controlled by manually or automatically regulating the flow of steam to the jacket. Alternatively, the heater may be a steam or electric coil inside storage tank 210. Those of ordinary skill in the art would be able to readily identify equipment suitable for storage tank 210, an agitator, and a heater based on the disclosure herein.

In an alternative embodiment, waste sludge stream 3 may be filtered before being introduced into storage tank 210. For example, waste sludge stream 3 may be passed through an internal or external screening device suitable for preventing any miscellaneous trash or other large contaminants from entering storage tank 210. Any conventional or later-developed screening device suitable for this purpose may be used in these embodiments. The screening device may include an in-line screen having a mesh size selected to enable sufficient flow of the waste sludge, but to prevent any miscellaneous trash or other large contaminants from entering storage tank 210. Those of ordinary skill in the art will be capable of identifying or designing an appropriate screening device, based on the disclosure herein.

As shown in FIG. 1, the waste sludge stream 4 may be pumped from storage tank 210 to sparge tank 220. Sparge tank 220 may be of any conventional type or shape suitable for holding the waste sludge. Sparge tank 220 may be constructed from steel or other material resistive to corrosion and heat. In one embodiment, sparge tank 220 may be adapted to heat the waste sludge from 90° F. to about 150-220° F. to facilitate separation of the grease from the solids. Any of the heating means described above with reference to storage tank 210 may also be suitable for tank 220. In one embodiment, steam may be continuously injected into tank 140 via a pipe (not shown) connected to a steam supply header. For example, the pipe may be a perforated pipe distributor inserted near the bottom of tank 220 for introducing the steam into the tank's contents. The rate of steam may be manually or automatically controlled to adjust or maintain the temperature in tank 200.

Referring to FIG. 1, the heated waste sludge stream 5 may be pumped from sparge tank 220 to a first separator 230. In one embodiment, first separator 230 may be a horizontal decanting centrifuge adapted to effect two-phase liquid/solid separation. In this type of centrifuge (not shown), the heated waste sludge may be fed into the bowl via a stationary inlet tube and an inlet distributor, as is well-known in the art. Centrifugal force leads to sedimentation of the solids on the bowl wall. Because the immiscible liquid mixture of grease and water is less dense than the solids, it forms a concentric inner layer. A screw conveyor, rotating in the same direction as the bowl, but with a differential speed, conveys the solids to conical end. The solids are lifted clear of the liquid mixture and centrifugally dewatered before being discharged into a collecting channel. After the solids are separated, the clarified immiscible liquid mixture flows into a housing through an opening at the end of the centrifuge. The separated solids 6 may then be removed via pump from the collecting chamber to an open top trailer and transported to a landfill. The immiscible liquid mixture 7 may be removed as it overflows weirs at the liquid discharge end.

The speed at which first separator 230 rotates and the selected diameter of the screw conveyor may depend on differential densities of the components in the waste sludge. Further, the diameter of the screw conveyor may be varied or selected depending on the size of the solid particles expected in waste sludge stream 5. One of ordinary skill in the art can readily determine the speed of rotation and the diameter of the screw conveyor to most efficiently effect separation.

As shown in FIG. 1, first separator 230 may have a normally-closed bypass line. The bypass line may allow for the immiscible liquid mixture 7 to bypass downstream equipment and be recycled back to pretreatment facility 100. The bypass line may be manually controlled and may be used during an upset in the downstream operation or when there is not an appreciable amount of grease in the waste sludge. The bypass line may also be used when downstream equipment is temporarily out of service. One of ordinary skill in the art would be able to identify the appropriate device or devices suitable for the outlet bypass stream, based on the disclosure herein.

Again referring to FIG. 1, immiscible liquid mixture 7 may be discharged from first separator 230 and be fluidly connected to a heat exchanger 240. Heat exchanger 240 may be of any conventional type suitable for heating immiscible liquid mixture 7. The immiscible liquid mixture 7 that flows from first separator 230 may be at a reduced temperature because of ambient heat losses. In heat exchanger 240, immiscible liquid mixture 7 may be heated from a temperature of about 130-220° F. to about 200-250° F. to ensure a sterile grease product and prevent the immiscible liquid mixture from solidifying. In one embodiment, steam may be continuously injected into heat exchanger 240 via a pipe connected to the steam supply header. Steam may be injected into the waste sludge using a perforated pipe distributor 241 inserted in heat exchanger 240. In one embodiment, the holes in the perforated pipe may spiral in the axial direction. The steam flow rate may be manually or automatically controlled to adjust the temperature of immiscible liquid mixture 7.

In an alternative embodiment, heat exchanger 240 might be a shell and tube heat exchanger, plate and frame heat exchanger, or any other type of heat exchanger. One of ordinary skill in the art will be able to determine a suitable type of heat exchanger and heating medium based upon the desired operating and process conditions, in view of teachings provided herein.

After the heated immiscible liquid mixture 8 leaves heat exchanger 240, it may pass through an in-line flocculator 250, as shown in FIG. 1. In-line flocculator 250 may be a series of eight (8) ninety-degree (90°) bends in the process line. In-line flocculator 250 may create turbulence and coagulate the grease in immiscible liquid mixture 8. Coagulating the grease may increase the downstream equipment's separation efficiency. In an alternative embodiment, chemical coagulants or flocculants may be injected into the process stream to coagulate the grease. It is understood that those skilled in the art can readily assess the need for and implementation of an appropriate type of flocculator, based on the teachings herein.

Heated immiscible liquid mixture 9 may be fluidly connected to a second separator 260 after it passes through in-line flocculator 250. In one embodiment, second separator 260 may be a disc-stack centrifuge adapted to effect liquid/liquid separation. In this type of centrifuge (not shown), the immiscible liquid mixture enters through the top and flows to the bottom where it may be radially diverted. The disc inserts, which comprise the heart of the disc-stack assembly, may be conical in shape and are assembled with circular or long rectangular plates known as caulks, which are fitted between adjacent disc inserts. Separation channels are formed as a result, and the thickness of the caulks may be varied so as to adjust the height of the separation channel for the particular particle size and concentration. Due to the centrifugal force, the grease enters each separation channel at its outer radius edge and flows upwardly and radially inward through the channel to its point of exit at the inner radius edge. Separation of the water and any residual solid particles occurs as the grease flows through the separation channels. The water flows upwardly between the outer casing of the centrifuge and the outer radius edges of the discs.

The separated water 11, which may be high in biological oxygen demand (“BOD”), may be discharged at the top of second separator 260. In one embodiment, separated water 11 may be recycled back to pretreatment facility 100. The highly concentrated recovered grease 10 may also be discharged from the top of the second separator 260 by gravity. Recovered grease 10 may be fluidly connected to a grease holding tank, not shown. The grease holding tank may include a suitable heater to maintain the contents in a suitable fluid state for pumping.

Further, recovered grease 10 may be circulated throughout the animal processing plant and may be used as industrial fuel to generate energy. Alternatively, grease 10 may be sold as raw material for biodiesel production, or used in other applications.

It will be obvious to those skilled in the art to make various changes, alterations and modifications to the process and apparatus described herein. To the extent such changes, alterations and modifications do not depart from the spirit and scope of the appended claims, they are intended to be encompassed therein.

What is claimed is:

1. A method for recovering grease from wastewater, the method comprising:
receiving wastewater comprising an aqueous phase and an organic phase, wherein the organic phase comprises solids and grease;
pretreating the wastewater to produce a waste sludge stream comprising water, solids, and grease, wherein a substantial amount of the solids and grease from the wastewater are extracted into the waste sludge stream;
separating the waste sludge in a first separation stage to provide a first separation phase consisting essentially of solids, and a second separation phase comprising an immiscible liquid mixture of grease and water; and
separating the second separation phase to provide a third separation phase consisting essentially of water and a fourth separation phase consisting essentially of grease.

2. The method of claim 1, wherein the wastewater is from an animal processing plant.

3. The method of claim 2, wherein the wastewater originates from one or more waste streams from inside the animal processing plant.

4. The method of claim 1, wherein the organic phase of the wastewater stream comprises sand, grit, animal by-products, animal waste, blood, fine bone, tissue, muscle, hair, nails, or a combination or mixture thereof.

5. The method of claim 1, whereby pretreating the wastewater comprises a dissolved air flotation system.

6. The method of claim 5, whereby pretreating is conducted at an operating temperature of about 90° F.

7. The method of claim 1, wherein the waste sludge stream comprises from about 60%-90% water, from about 5%-30% grease, and about 5%-30% solids.

8. The method of claim 1, further comprising the step of heating the waste sludge stream to a temperature of about 150-220° F.

9. The method of claim 1, further comprising the step of heating the second separation phase to a temperature of about 200-250° F.

10. The method of claim 1, further comprising the step of coagulating the grease in the immiscible liquid mixture.

11. A system for recovering grease from wastewater, the system comprising:
a pretreatment facility capable of extracting a substantial portion of the solids from the wastewater stream to produce a waste sludge;
a first separator capable of separating the waste sludge into a first separation phase consisting essentially of solids from the waste sludge, and a second separation phase comprising an immiscible mixture of water and grease;
a second separator capable of separating the second separation phase into a third separation phase consisting essentially of water, and a fourth separation phase consisting essentially of grease.

12. The system of claim 11, wherein the wastewater is from an animal processing plant.

13. The apparatus of claim 11, wherein the pretreatment facility is a dissolved air flotation system.

14. The apparatus of claim 11, whereby the pretreatment system comprises a heater for maintaining the temperature of the wastewater at about 90° F.

15. The system of claim 11, further comprising a holding tank downstream of the pretreatment apparatus.

16. The system of claim 11, further comprising a sparge tank downstream of the holding tank, wherein said sparge tank is capable of heating the waste sludge to a temperature of about 150-220° F.

17. The system of claim 11, wherein the first separator means is a two-phase solid/liquid decanter centrifuge.

18. The system of claim 11, further comprising a heat exchanger downstream of the first separator that heats the immiscible mixture of water and grease to a temperature of about 200-250° F.

19. The system of claim 11, further comprising an in-line flocculator to coagulate the grease in the immiscible mixture of water and grease.

20. The system of claim 11, wherein the second separator is a two-phase liquid/liquid separator.
